(19) United States
(12) Patent Application Publication
(10) Pub. No.: US 2023/0284349 A1
(43) Pub. Date: Sep. 7, 2023

(54) HEAT-NOT-BURN DEVICE AND METHOD

(71) Applicant: CQENS Technologies Inc., Minneapolis, MN (US)

(72) Inventors: Alexander Chinhak Chong, St. Louis Park, MN (US); William Bartkowski, Edina, MN (US); David Crosby, Watsonville, CA (US); David Wayne, Aptos, CA (US); Gerard Shudall, Liverpool (GB)

(21) Appl. No.: 17/687,470

(22) Filed: Mar. 4, 2022

(51) Int. Cl. H05B 6/10

(52) U.S. Cl. CPC H05B 6/105; H05B 6/106; A24D 1/20

(57) ABSTRACT

A susceptor for use in a heat-not-burn device, and a method of manufacturing thereof, using metal pieces incorporated together into a single unitary piece using a variety of techniques, such as compacting, heat and pressure, sintering, weaving, extruding, and the like, such that the susceptor is susceptible to degradation after use.

### TECHNICAL FIELD

This invention relates to methods for configuring and manufacturing susceptors, particularly, for use in devices for aerosolizing medicants via a high--temperature.

### BACKGROUND

When faced with a condition giving rise to bodily discomfort, such as a diseased state, disorder, ailment, normal bodily disruptions, and the like, most people turn to medicants, such as drugs, supplements, herbs, and the like for immediate relief from the symptoms that arise from the underlying condition. There are certain legal and widely available over-the-counter (OTC) medications and supplements that have beneficial effects when used for a variety of common conditions. There are also certain controlled narcotics and pharmaceuticals prescribed by doctors for a variety of more serious conditions.

One of the most common routes of administration of these OTC and prescription drugs is oral administration. As with any oral delivery of medication, however, it must pass through the digestive tract. There are a number of disadvantages of oral administration. For example, because the drug has to pass through the digestive system, the onset of activation of the drug is slow. In addition, in the digestive tract the drug may be inactivated or destroyed, and therefore, lose its potency or efficacy. The drug itself can also cause problems in the digestive tract, or side effects, such as loss of appetite, diarrhea, acidity, and the like. Furthermore, patients may be reluctant or unable to swallow oral medication in the form of a pill.

Certain medicants are intended to affect the brain or the brain’s actions or activities but, given the accepted method of ingestion--gastrointestinal, intravenous, or intramuscularthese medicants can also have a variety of discomforting side effects due to the nature of ingestion or injection. These include, but are not limited to gastro-intestinal complications, digestive disorders, high blood pressure, and/or headaches, as well as the reluctance of users to self-administer medicants by injection.

Other routes of delivery exist, such as intradermal injections, patch applications, inhalations, and the like. Each of these has its own advantages and disadvantages. Therefore, there is still room for improving routes of administration of medicants.

For example, there are varieties of medicants that are safer, more effective, and more efficient with respect to both safety and efficacy if their ingestion is via inhalation of an aerosol, such as a gas, vapor, mist, and any other inhalant, containing the medicant or its active ingredient rather than by gastrointestinal, intravenous or intramuscular delivery.

Additionally, certain methods to aerosolize and deliver these medicants have drawbacks as well, specifically those that aerosolize the medicant itself, changing the molecular or chemical structure of the medicant or those that might aerosolize at a high temperature-extending the duration heating and raising the risk of changing the molecular or chemical structure of the active ingredient. Other drawbacks of current aerosolization techniques include the transport, storage and merchandising of certain of these medicants in cartridges that are prone to leaking and, in many cases, are designed and constructed with cartridge materials that are not environmentally friendly, containing plastics and other materials that are not biodegradable.

In order to ensure that the medicant is delivered intact via the high temperature, non-combusting inductive method, it is preferred that the method of aerosolization does not change the chemical or fundamental molecular structure of the medicant or other materials that make up the medicant, or if such changes occur, that they will not interfere with, and/or improve, the efficacy of the medicant.

Therefore, there is still a need for improving the routes of administration of medicants. In particular, there is still a need for improving methods of aerosolizing medicants for inhalation that would also provide the added benefit of metering, monitoring and measuring inhalers exact dosages without destroying the active ingredient or adding other chemicals to the aerosol as a result of energy inefficiency or prolonged heating duration. There is also the need for consumable embodiments that are biodegradable and do not contain materials that are not consistent with environmentally friendly disposal.

In addition to medicant delivery systems, heat-not-burn (HNB) devices are a type of device generally used to heat tobacco at temperatures lower than those that cause combustion to create an aerosol containing nicotine and other tobacco constituents, which is then made available to the device’s user. In some embodiments, the heated element or susceptor is placed inside a solid tobacco product with a coil wrapped around the tobacco product and susceptor to cause the susceptor to heat through an inductive mechanism. Unlike traditional cigarettes, the goal is not to burn the tobacco, but rather to heat the tobacco sufficiently to release the nicotine and other constituents through the production of aerosol. Igniting and burning the cigarette creates unwanted toxins that can be avoided using the HNB device. There is a fine balance, however, between providing sufficient heat to effectively release the tobacco constituents in aerosol form and not burn or ignite the tobacco. Current HNB devices on the market have not found that balance, either heating the tobacco at temperatures that produce an inadequate amount of aerosol or over heating the tobacco and producing an unpleasant or “burnt” flavor profile. Additionally, the current methodology leaves traditional HNB device internal components dirtied with burning tobacco byproducts and the byproducts of accidental combustion.

Furthermore, in order to ensure the state change from a solid or liquid state to an aerosol state in a rapid, energy efficient manner via high temperature, non-combusting inductive heating, the formulation must be configured in a way that eliminates air flow between the formulation and the inductive system’s susceptor. Therefore, there is a need for a device, method, and formulation that provides its user the ability to control the power of the device, which will affect the temperature at which the tobacco will be heated via the inductive method to reduce the risk of combustion — even at what would otherwise be sufficient temperatures to ignite — while increasing the efficiency and flavor profile of the aerosol produced.

These devices use inductive heating methods in which a susceptor embedded in the aerosol producing substrate is heated by coils wrapped around the aerosol producing substrate and the susceptor. Current susceptors are generally made from a piece of metal, which can contain heavy metals such as lead, cadmium, etc. One problem with current susceptors is that because they are flat pieces of metal, they can have very sharp edges and corners. As such, if the devices or susceptors are not disposed of properly, they could become an environmental hazard similar to having razor blades lying around in the environment. In addition, being a solid piece of metal, the current susceptors do not degrade rapidly in the environment.

Therefore, there is a need for a susceptor, and a method of manufacturing thereof, that is environmentally friendly without compromising the quality of heat generation.

### SUMMARY

The present invention is directed towards a method of configuring and manufacturing a susceptor that degrades over a relatively short period of time compared to standard susceptors made of metal alloys, particularly when the susceptor is exposed to a certain temperature. In particular, the susceptor can be composed of metal particles fused together, which will then more readily decompose when removed from a heat-not-burn device and exposed to the environment making this susceptor much more environmentally sound than other HNB susceptors, which do not degrade and hence become an environmental hazard.

In some embodiments, metal particles can be fused together to form a metallic sheet. The susceptors can be manufactured using a number of different fusing processes, such as using sintering, direct metal laser sintering, plasma sprayed powder, microwave assisted sintering, ultrasonic assisted sintering, direct pressure, electric current assisted sintering, powdered metallurgy, and the like.

In some embodiments, the susceptor can be formed via the weaving of “metal thread or wire” into a fabric-like sheet or ribbon, then cutting and using the sheet as the susceptor. This embodiment will also facilitate faster decomposition in the environment. Both embodiments feature a texturized surface, creating more surface area and optimizing the adhesion of the substrate to the susceptor, simplifying the consumable manufacturing process and ensuring the tightest possible seal between the substrate and the susceptor-allowing for an inductively heated, high temperature, non-combusting consumable due to the lack of oxygen between the substrate and the susceptor.

In any embodiment, a protective coating over the susceptor that burns off after the susceptor has been heated can be used, making the susceptor more prone to rapid breakdown when removed from the heat-not-burn device and exposed to the environment. Examples of protective coatings are a thin coating of PG sprinkled with PGA to form a gel seal around the susceptor, preventing the metal susceptor from oxidation or decomposition until after it has been used. Any suitable coating may be used, keeping in mind that any aerosol produced by the heated coating may be inhaled by the user.

### BRIEF DESCRIPTION OF DRAWINGS

FIG. 1 shows a side view inside of an embodiment of the present invention assembled in a HNB device.

FIG. 2A shows a perspective view of an embodiment of the present invention assembled into a consumable-containing package.

FIG. 2B shows a perspective view of the embodiment shown in FIG. 2A with portions of the consumable-containing package cut away and/or removed to reveal the susceptor.

FIG. 2C shows a cross-sectional view of the embodiment shown in FIG. 2A cut along line 2C-2C.

FIG. 2D shows an exploded view of the consumable-containing package shown in FIG. 2A.

FIG. 2E shows a perspective view of the consumable-containing package with another embodiment of the susceptor with portions of the consumable-containing package cut away and/or removed to reveal the susceptor.

FIG. 3A shows a perspective view of another embodiment of the susceptor.

FIG. 3B shows a side elevation view of the susceptor shown in FIG. 3A.

FIG. 3C shows a top plan view of the susceptor shown in FIG. 3A.

FIG. 4A shows a perspective view of another embodiment of the susceptor.

FIG. 4B shows a side elevation view of the susceptor shown in FIG. 4A.

FIG. 4C shows a top plan view of the susceptor shown in FIG. 4A.

FIG. 5 shows a close-up of the area designated as 5 in FIG. 4A.

### DETAILED DESCRIPTION OF THE INVENTION

The detailed description set forth below in connection with the appended drawings is intended as a description of embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The invention of the present application is a susceptor 106 for devices for generating aerosols from a consumable-containing product for inhalation commonly referred to as heat-not-burn (HNB) devices 100, wherein the susceptor 106 becomes degradable after it has been used in the HNB device 100. The susceptor 106 is the component that is heated through the inductive method and heats the aerosol producing substrate 104 from the inside out. As such, the susceptor 106 is made of a metal that can be heated through an inductive method, such as ferrous metals. HNB devices 100 utilize relatively high heat with minimal burning of the consumable-containing product. The susceptor 106 of the present invention is configured to become degradable after being heated during the inductive heating process when the HNB device 100 is used.

For the purposes of this application, the term “consumable” is to be interpreted broadly to encompass any type of pharmaceutical agent, drug, chemical compound, active agent, constituent, any other medicant, and the like, regardless of whether the consumable is used to treat a condition or disease, is for nutrition, is a supplement, or used for recreation. By way of example only, a consumable can include pharmaceuticals, nutritional supplements, and over-the-counter medicants, such as but not limited to, tobacco, cannabis, hemp, lavender, kava, coffee, caffeine, lobelia, hoodia, melatonin, epimedium, guarana, ginseng and the like.

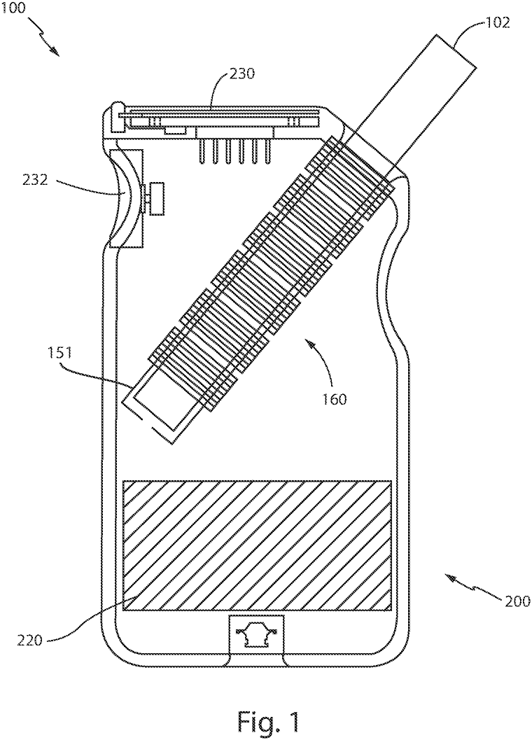

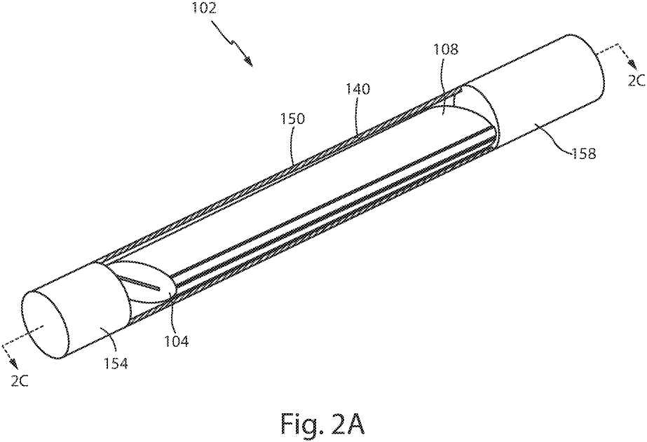

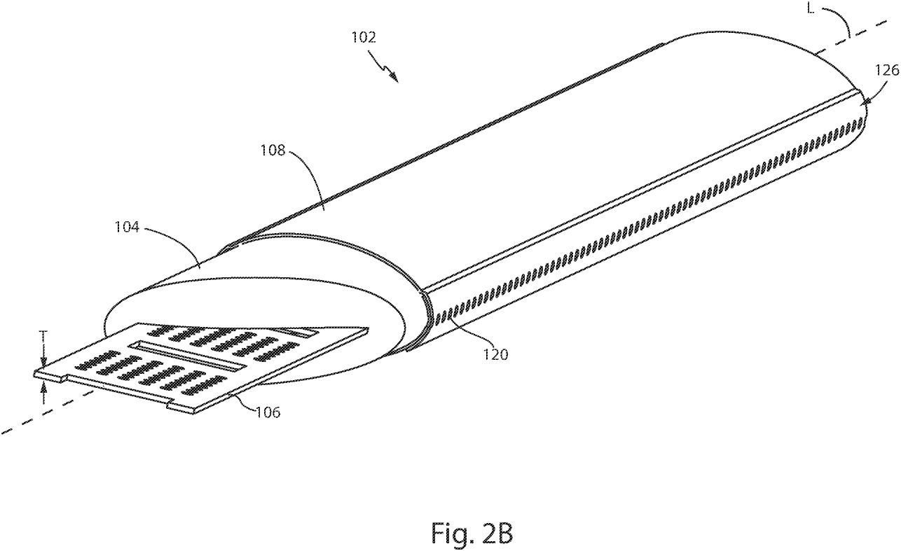

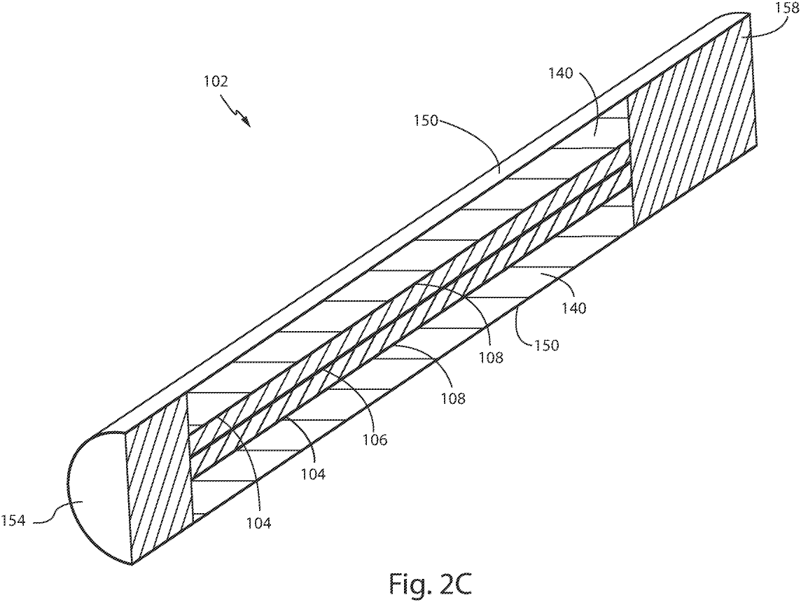

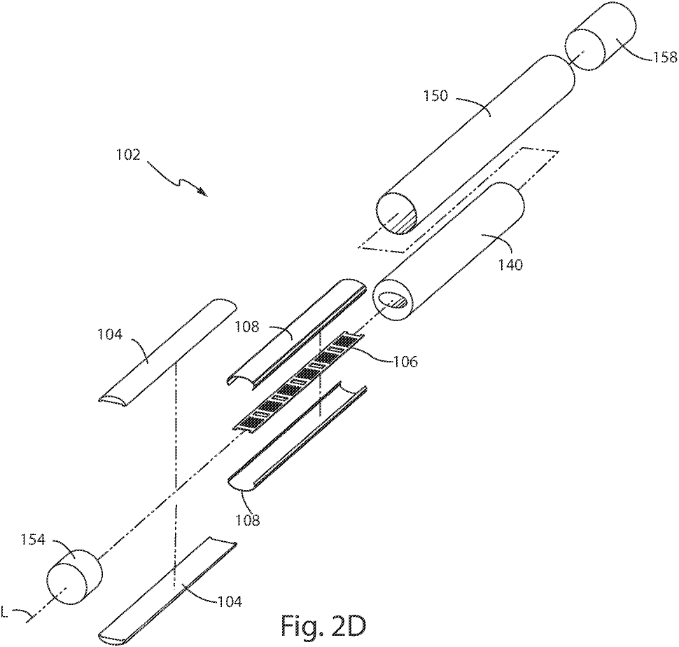

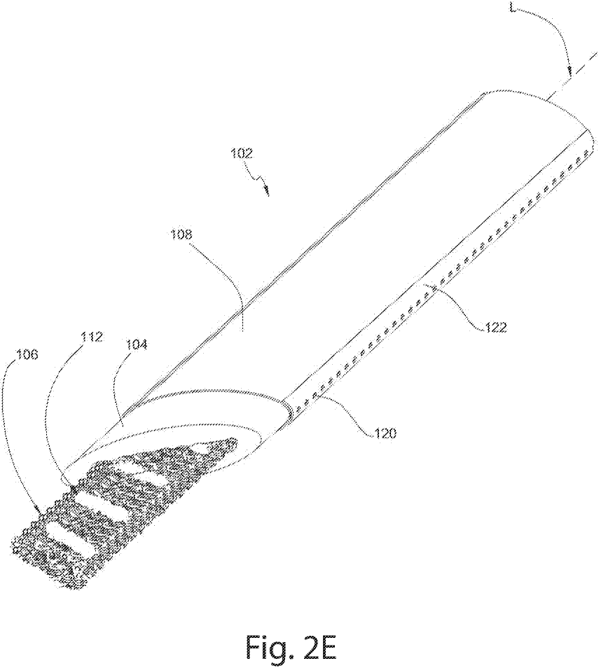

An example of an HNB device is shown in FIGS. 1-2E, and described fully in U.S. Pat. No. 10,750,787; PCT/US2019/012204; and PCT/US2020/040779, which are all incorporated in their entirety here by this reference. The device 100 comprises a consumable-containing package 102 and an aerosol producing device 200. The device 100 generates aerosols through a heat-not-burn process in which an aerosol producing substrate 104 is exposed to an aerosolizing thermal state, such as high aerosolizing temperatures and the absence of oxygen, that does not burn an aerosol producing substrate 104 within the consumable-containing package 102, but does release the active ingredient from the aerosol producing substrate 104 in the form of an aerosol product that can be inhaled. Thus, an aerosol producing substrate 104 is any product that contains an active ingredient that can be released into aerosol form when heated to the proper temperature and condition. Any description of the invention to a specific application, such as to a tobacco product, is provided only as a concrete example, and is not intended to be limiting. As such, the invention is not limited to use with tobacco products only.

With reference to FIG. 1, the aerosol producing device 200 comprises a receiver 151 to contain a consumable-containing package 102, an induction heating element 160 to heat the susceptor 106, a system controller to control the induction heating element 160, and a power source 220 to power the device 100. A user interface 230 can be provided to facilitate ease of operation. A trigger 232 can be provided to actuate the device 100.

The consumable-containing package 102 is the component that is heated to release the consumable in aerosol form. The consumable-containing package 102 comprises an aerosol producing substrate 104, and the susceptor 106 surrounding the aerosol producing substrate 104 for heating the aerosol producing substrate 104 from the inside out through an inductive heating system. In some embodiments, the consumable-containing package 102 can have an encasement 108 to contain the aerosol producing substrate 104 and the susceptor 106.

The encasement 108 may be configured with holes 120 to allow the aerosol to escape from the encasement 108, or the encasement may be a permeable membrane to allow the aerosol to escape. The aerosol producing substrate 104 can be placed inside a housing 150 that can mimic a cigarette. In some embodiments, a filter 140 can surround the encasement 108. The housing 150 may be capped with an end cap 154 at one end and a mouthpiece 158 at the opposite end. The end cap 154 may be comprised of a type of filter material. The mouthpiece 158 allows the user to draw the heated consumable aerosol out of the aerosol producing substrate 104 along the housing 150 towards the mouthpiece 158 and into the user’s mouth. As such, the mouthpiece 158 may also comprise a type of filter, similar to that of the end cap 154.

The invention of the present application is directed towards the susceptor 106 that can be used for these and other HNB devices. Unlike existing susceptors, which can be made up of a single, solid piece of metal, the susceptor 106 of the present invention is configured to become degradable after it has been used in a HNB device 100. As such, when existing susceptors are discarded, they maintain their original form, which tends to be a flat, rectangular piece of metal. In addition, the edges of the flat, rectangular piece of metal can be very sharp. As such, if existing susceptors are not disposed of properly, for example, by being wrapped up in paper or tape, or placed in containers for collecting sharp items, then sharp, razor-like susceptors could be introduced into the environment, where harm can be imposed on unsuspecting children, animals, and adults, who may accidentally step on, pick up, or even ingest these susceptors.

The susceptor 106 of the present application, however, is configured to be environmentally safer than prior art susceptors. For example, the susceptor 106 can be made of material that is a softer, more malleable metal than prior art susceptors, and therefore, is less likely to injure and/or have sharp edges. In some embodiments, the susceptor 106 can be made of material that will degrade (e.g., through oxidation) in a relatively short period of time. In some embodiments, the susceptor 106 can be configured to degrade or dissociate into smaller pieces to the point where it is no longer a single unitary piece, but rather a plurality of fragmented pieces, when exposed to certain conditions. As a result, the susceptor 106 may no longer be a single, unitary piece with stiff or sharp characteristic, but rather, may become friable in that the susceptor can be easily broken down into small fragments, crumbled, or reduced to powder. As such, when the degradable susceptor 106 is disposed of, it will be less harmful in the environment as it starts to degrade.

Examples of materials that can be used to manufacture the susceptor 106 include, but are not limited to, any one or more of the following: iron or iron based alloys. Specifically, the susceptor may comprise approximately 50 percent to approximately 99.99 percent iron or iron-based alloys. Preferably, the susceptor 106 may comprise approximately 98 percent or more of iron or iron-based alloys. In some embodiments, the susceptor 106 may comprise pure iron (100 percent iron).

Examples of conditions that can degrade the susceptor 106 include, but are not limited to, any one or more of the following: time, heat, pressure, sudden force, chemicals, water, and the like. In the preferred embodiment, the susceptor 106 can become more friable than current susceptors, even without heat, when exposed to the environment. As such, prior to its first use, the susceptor 106 may have structural integrity and stiffness, making it easy to handle during the manufacturing process of the HNB device 100, particularly, when the susceptor 106 is being assembled with the aerosol producing substrate 104. Once the susceptor 106 is incorporated into the aerosol producing substrate 104 and inserted into the device 100, it is ready for use. During use, the susceptor 106 is heated to an aerosolizing temperature that releases the active ingredient (medicant) from the aerosol producing substrate 104 in the form of an aerosol. That aerosolizing temperature can be high enough that it causes the susceptor 106 to become friable so that it can degrade when removed from the heat-not-burn device and left in the environment. Because the aerosol producing substrate 104 has been used in that area of the susceptor 106, that the susceptor 106 in the used area becomes friable is of no consequence for the user.

In some embodiments, a coating may be applied to the susceptor 106 that protects the susceptor 106 from premature degradation until after the aerosol producing substrate has been used. An example of this would be to put a coating of any one or more of propylene glycol (PG), vegetable glycerin (VG), polysorbate, paraffin, or the like, on the metal susceptor 106 followed by adding a dusting material to the susceptor 106, such as an alginate (e.g., propylene glycol alginate (PGA)), or any kind of starch, which can turn the coating (e.g., PG, VG, polysorbate, paraffin, and the like) into a gel. By way of example only, the ratio of the coating to the dusting material can be approximately 99:1 to convert the coating to a gel.

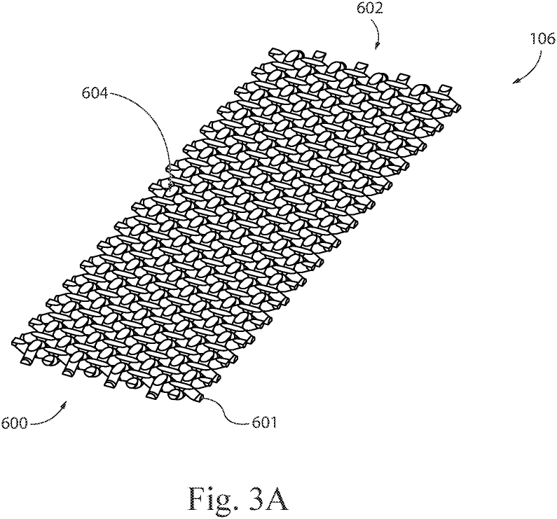

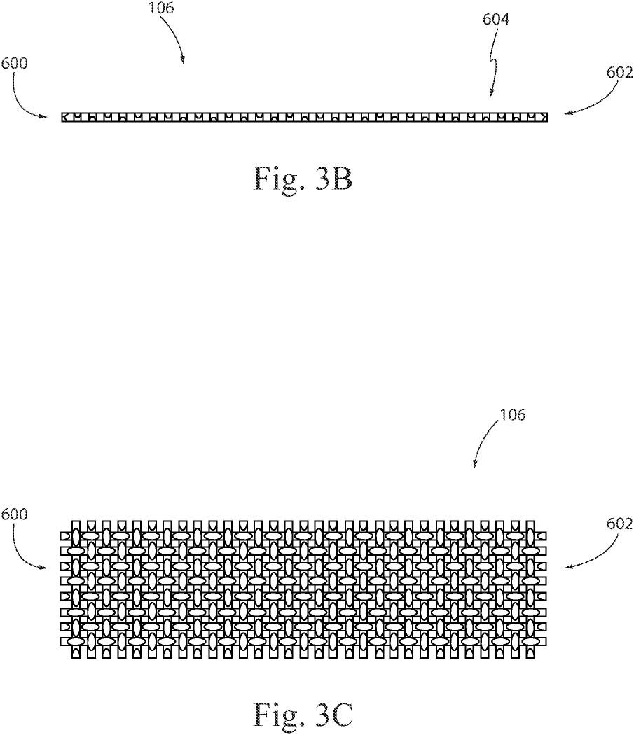

A variety of techniques can be used to manufacture the susceptor 106 that becomes friable after use (or exposure to high aerosolizing temperatures). As shown in FIGS. 3A-5, the degradable susceptor 106 can be comprised of a plurality of metal pieces 601 that are incorporated together as a unitary piece. The susceptor 106 can be made of any metal material that generates heat when exposed to varying magnetic fields as in the case of induction heating. Ferro-magnetic metals are preferable. In a preferred embodiment, when the temperature of the susceptor 106 of the present invention is elevated during use, it becomes more friable, and therefore more susceptible to degradation. Also, the protective coating on the susceptor will vaporize at elevated aerosolizing temperatures, exposing the surface of the susceptor to more rapid degradation when exposed to the environment. By way of example only, aerosolizing temperatures that can render the susceptor 106 friable may be from approximately 20° C. to approximately 800° C. Preferably, temperatures that can render the susceptor 106 friable may be from approximately 40° C. to approximately 600° C. More preferably, temperatures that can render the susceptor 106 friable may be from approximately 250° C. to approximately 500° C. For example, aerosolizing temperatures that can render the susceptor 106 friable may be from approximately 200° C. to approximately 350° C. In some examples, aerosolizing temperatures that can render the susceptor 106 friable may be from approximately 40° C. to approximately 150° C.

The susceptor 106 can have a shape that is generally cylindrical, block-shape, flat, and the like, and even amorphous. Preferably, the unitary piece is a flat “sheet” comprising metal. In the preferred embodiment, the susceptor has a first end 600, a second end 602, and a surface 604 there between. Because the susceptor 106 is comprised of multiple smaller pieces 601 (e.g., fragments, particles, metal shavings, metal powder, granules, fibers, strands, and the like) the surface 604 of the susceptor 106 can be uneven. Although the general appearance of the surface 604 may appear flat or smooth, closer examination reveals that the surface has a plurality of nooks and crannies, hills and dips, and other undulations that create an uneven surface as shown in FIG. 5. The uneven surface also increases the overall surface area compared to a smooth surface. Due to the unevenness, the surface 604 feels textured rather than smooth. The textured surface 604 improves the area of contact made with the aerosol producing substrate 104. In addition, the textured surface 604 can improve the adhesion with the aerosol producing substrate 104. The uneven points on the surface 604 of the susceptor 106 can be embedded into the aerosol producing substrate 104. Having the uneven points embedded into the aerosol producing substrate 104 increases the area of contact between the susceptor 106 and the aerosol producing substrate 104. Allowing the aerosol producing substrate 104 to embed into the nooks and crannies of the surface 604 of the susceptor 106 eliminates the oxygen between the susceptor 106 and the aerosol producing substrate 104.

The aerosol producing substrate 104 can be configured to minimize the amount of air to which the aerosol producing substrate 104 is exposed. This eliminates or mitigates the risk of oxidation during storage or combustion during the heating process. As a result, at certain settings, it is possible to heat the aerosol producing substrate 104 to temperatures that would otherwise cause combustion when used with prior art devices that allow more air exposure. As such, in some embodiments, the aerosol producing substrate 104 is made from a powdered form that is compressed into a hard, compressed pellet or rod. Compression of the aerosol producing substrate 104 reduces the oxygen trapped inside the aerosol producing substrate 104, and limits the migration and availability of oxygen in the aerosol producing substrate 104 during heating.

In some embodiments, the aerosol producing substrate 104 and/or the susceptor 106 can be mixed with a substance that does not interfere with the function of the device 100, but displaces air in the interstitial spaces of the aerosol producing substrate 104 and/or surrounds the aerosol producing substrate 104 to isolate it from the air. For example, the substance can be an additive, such as a humectant, flavorant, filler to displace oxygen, or vapor-generating substance, and the like. The additive may further assist with the absorption and transfer of the thermal energy as well as eliminating the oxygen from the aerosol producing substrate 104. The additive may also serve as a corrosion inhibitor for the metal susceptor material.

In some embodiments, the susceptor 106 may be made of metal wool as shown in FIG. 2E. For example, the susceptor 106 may be comprised of fine filaments of metal wool bundled together in the form of a pad. As such, the metal wool pad comprises numerous fine edges.

In some embodiments, the susceptor 106 may be doused with, immersed in, or fully filled with an additive, such as a humectant, flavorant, vapor-generating substance, a substance to retard oxidation of the susceptor 106, and/or a filler to eliminate air between the metal pieces 601, and the like. There may be cut-outs or gaps 112 along the susceptor 106 to divide the aerosol producing substrate 104 into discrete segments for individual heating segments. Alternatively, individual susceptors 106 may be used, separated by space and/or consumable, so that each susceptor 106 may be heated individually during use.

In the preferred embodiment, the susceptor 106 can be made from metal alloys, such as low-carbon steel. Advantages of the low-carbon steel, include, but are not limited to, easy disposability from an environmental standpoint in that it begins to oxidize soon after it is heated; and thereby, becomes friable and degrades easily without dangerous sharp edges. Also, metals composed of iron and carbon are relatively non-toxic.

However, alloyed metals can contain elements or chemicals that are considered hazardous such as nickel, chromium, lead, and other metals that are undesirable if released into the environment or potentially inhaled by the user. These elements can provide the structural properties that an alloy like low carbon steel display. The susceptor 106 of the present application, however, does not seek the kind of structural integrity used in prior art susceptors because of the desire for the susceptor 106 to degrade after use. As such, in the preferred embodiment, the susceptor 106 has poorer structural properties (poor tensile, elasticity, ductility, and malleability properties) compared to prior art susceptors made with metal alloys. The susceptor 106 of the present invention can be made of material that can mechanically disintegrate (break apart) and chemically decompose (oxidize) rapidly if disposed of in the environment. A brittle susceptor 106 with less structural integrity is desired because, for example, it reduces the risk of harm if accidently ingested by or exposed to animals or humans.

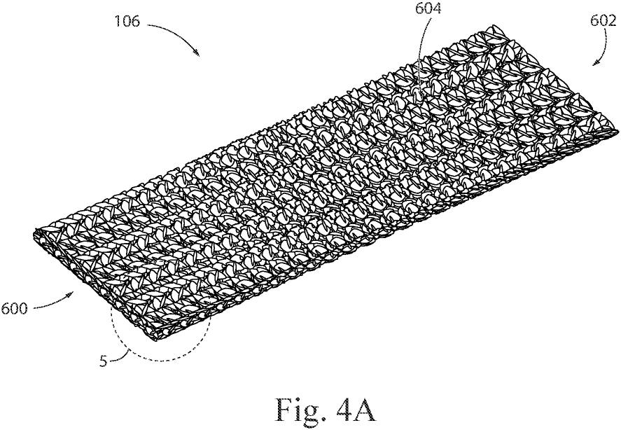

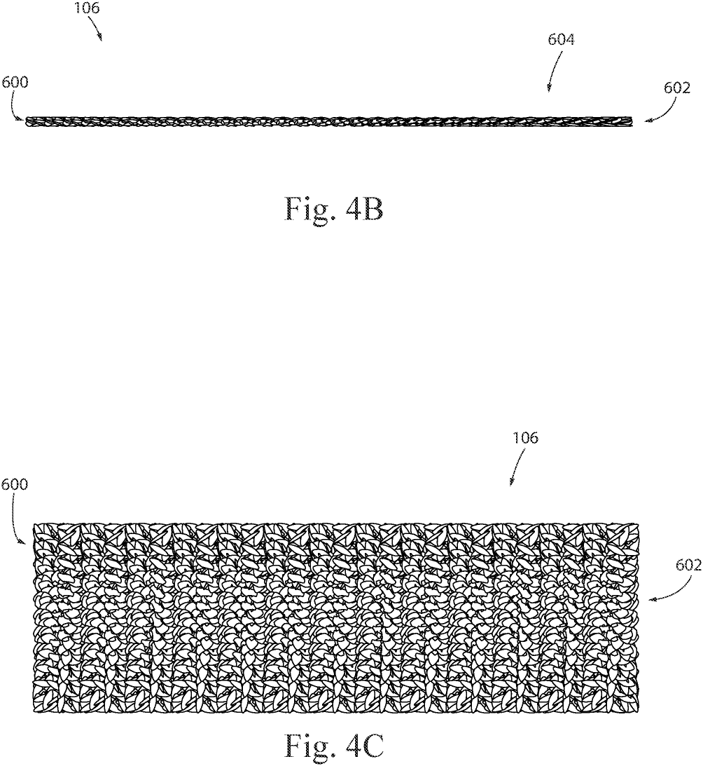

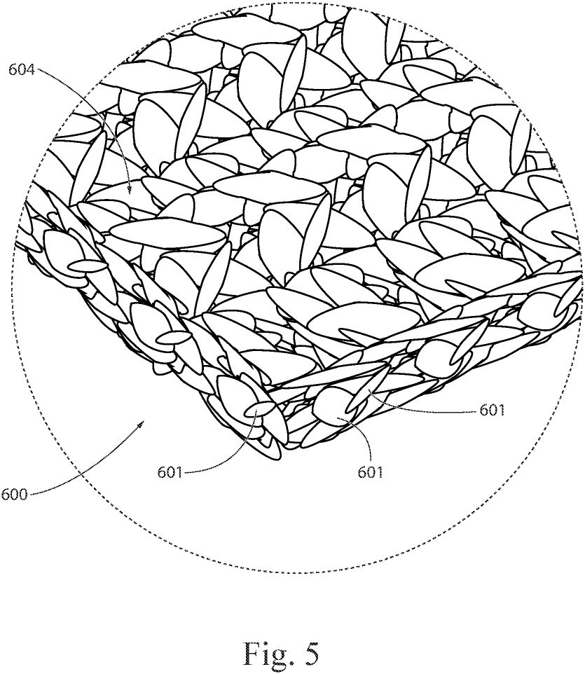

In some embodiments, pure iron powder can be used as an excellent, low cost, easily available ferromagnetic metal. Iron alone has poor structural properties when the particles are fused together, yet retains excellent ferromagnetic properties that are required for inductive heating. Without being bound by theory, it is believed that the metal pieces must be fused together across the boundaries of the particles for the best possible susceptor performance. As such, as shown in FIGS. 4A-4C, and 5, the metal pieces 601 can be metal particles, metal shavings, metal powder, fibers, strands, and the like, or any combination thereof, that can be fused together.

In some embodiments, to fuse the metal pieces 601 together, the metal pieces 601 may be compacted with a press. In some embodiments, the metal pieces 601 may be fused together with heat. In some embodiments, the metal pieces 601 may be fused together using heat and pressure, for example with a hot press. In some embodiments, the metal pieces 601 may be fused together with a binder, such as copper, paraffin, or other metallurgical binder. Preferably, a sintering process is used to fuse the metal pieces 601 together.

In some embodiments, direct metal laser sintering (DMLS) can be used. A smooth and level layer “bed” of iron metal powder can be spread out a on a flat surface. Using a laser, the shape of the desired susceptor on the bed of loose metal powder can be drawn and filled in. The laser cycle fuses the exposed particles together without full liquification of all the powder particles.

In the preferred embodiment, pure iron powder (i.e., 99.9% lab grade pure reduced iron) can be used. Other powdered metal types and alloys (mixtures) could also be employed. By way of example only, small pieces of iron, such as iron powder or granules, can be turned into small balls of iron during the DLMS or other sintering process, which may enhance their inductive heating design properties. Each of the balls of iron can be fused together to the shape of the susceptor 106. This shape can be fully designable by guiding the laser duration, intensity of power, and the pattern of movement of the laser beam. The roughness of how the balls of iron are fused together (i.e. the surface texture), preferably, gives an uneven and rough surface area for the tobacco to adhere to the susceptor 106. The use of powdered tobacco or other medicant compressed onto the susceptor 106 having this rough surface area may provide better adhesion. After use (e.g., one heating), the susceptor 106 may break down to small balls of iron which will degrade (rust) in the environment quicker than traditional susceptors.

Laser speed, energy and frequency can all have different effects on the surface finish, strength, thickness, and speed of sintering production cycle. Metal particle size (mesh) and shape can also influence the final surface finish and strength of the final susceptor product. The laser speed refers to the linear velocity of the beam movement across the surface of the powder bed. The laser energy refers to the optical power the laser can deliver per unit time.

The metal particle size can range from 1 micrometer to approximately 2 mm in any given direction. An advantage of laser sintering metal powder is that through use of different metal particle sizes, the porosity, density, and inductive characteristics can be controlled for the fused susceptors. Another advantage of a sintered metal susceptor is it allows the use of different particle sizes and shapes allowing for the control of the rate at which the susceptor will degrade in the environment.

By way of example only, the power of the laser can be controlled to make the balls of iron bigger or smaller based on the intensity of the laser. The speed with which the laser travels over the surface of the small balls of iron can be controlled to adjust the strength of fusion of the bonds between each of the balls. The movement of the laser can be controlled to adjust the shape (width, height and length) of each susceptor 106, and can even make susceptors 106 in a specific pattern. For example, the susceptors 106 can be custom designed to create text or recognizable shapes, patterns, objects, animals, people, and the like. In addition, the shape of the susceptor 106 can be designed in ways to improve adhesion of the aerosol producing substrate, such as creating gaps in the susceptor 106 so that the aerosol producing substrate (e.g. powdered tobacco) can adhere to itself from two sides of the susceptor 106 through the gap.

The sintering process via laser is incredibly fast, resulting in susceptors 106 that are cheaper to make than traditional manufacturing processes for susceptors, while keeping the susceptor 106 pure, thereby avoiding the addition of any other harmful materials/alloy in the process. By optimizing the aforementioned factors, a susceptor 106 of the ideal surface finish, strength, and thickness can be created. The susceptor 106 can have a smoothed to a textured finish. Preferably, the surface is a textured finish to increase the surface area of contact with the aerosol producing substrate 104.

The thickness T of the susceptor 106 can range from approximately 1 micrometer to approximately 2 mm. Preferably, the thickness T of the susceptor 106 can range from 100 micrometers to 1.5 mm. More preferably, the thickness T of the susceptor can range from approximately 500 micrometers to 1 mm.

At the end of a laser sintering cycle the fused susceptor 106 can be handled and removed from the bed of surrounding loose un-sintered powder, and the un-sintered powder can be re-leveled for another sintering cycle. In some embodiments, an inert shielding gas such as argon, nitrogen, carbon dioxide, or mixtures of gases can be used to reduce oxidation during sintering. An endless assortment of susceptor shapes and patterns can designed and “drawn” on the bed of powder by the engraving laser.

Infrared (IR) and ultraviolet (UV) wavelength lasers are capable of sintering metal particles. Lasers with other optical wavelengths could be used, as well as electron-beam sintering.

In some embodiments, plasma sprayed powder can be used for the sintering process. Plasma sprayed powder is a process where metal powder is superheated and sprayed at high pressure through a plasma flame toward a build surface, much like an inkjet printer shoots ink across an air gap to the surface of paper. The metal powder can be fed through a powder feeder into the path of a plasma flame. The plasma flame then heats the powder towards the build surface to create the susceptor.

Other sintering processes can be used, such as microwave sintering in which a waveguide can be used to direct microwave energy into a chamber where metal particles are rapidly fused together, ultrasonic assisted sintering, direct pressure, electric current assisted sintering, powdered metallurgy in which powder is pressed without heat to form a “green” state then post processed in a kiln or oven to fuse the particles together, and the like.

In some embodiments, the susceptor 106 can be machine extruded. Once extruded, the aerosol producing substrate 104 can be combined with the susceptor 106 by compressing it around the susceptor 106 along the length of the susceptor 106. Alternatively, the susceptor 106 could be stamped from flat metal stock or any other suitable method of fabrication prior to assembling the aerosol producing substrate 104 around the susceptor 106.

Preferably, the susceptor 106 is paper-thin. As such, the thickness T of the flattened susceptor 106 can be less than 0.1 inch. (2.54 mm) Preferably, the thickness of the susceptor 106 can be less than 0.05 inch. (1.27 mm) More preferably, the thickness of the susceptor 106 can be less than 0.025 inch, (0.635 mm) or even less than 0.01 inch. (0.254 mm) In some embodiment, the susceptor 106 can be as thin as 0.0039 inch (0.099 mm). The susceptor 106 can range in length from about 0.5 inch (12.7 mm) to about 1.25 inches. (31.75 mm). The length of the susceptor will vary based on the implementation of the device and its intended use in a heat-not-burn device. As such, reference to smaller pieces 601 in this application refers to fragments, particles, shavings, powders, granules, fibers, strands, and the like, that individually are generally smaller in total volume than the susceptor 106 being manufactured in order for the smaller pieces 601 to be combined and fused to form the susceptor 106.

A variety of techniques can be used to achieve a thin, flattened susceptor 106, including the sintering techniques. In some embodiments, the susceptor 106 may undergo a series of stretching and compressing until the desired thickness T is achieved. This may be accomplished via a rolling compression followed by a stamping process to get the requisite shape and texture, as well as other suitable methods. Once the desired thickness is achieved, the susceptor 106 can be cut into the desired shape and dimensions.

In certain embodiments, the use of steel wool for the susceptor, and making the steel wool thin, allows for easy and prolonged cutting because the blade for cutting the steel wool can last longer compared to traditional metals and thicker susceptors currently on the market. Furthermore, using steel wool is cheaper to make and requires less energy to heat up. In some embodiments, approximately one-third less energy is required to reach the same temperature of other non-steel wool susceptors. In some embodiments, steel wool materials used to make steel paper may require added lubricant while being shaved into small wool material. This could result in such lubricant being added to the finished steel wool material, resulting in decreased purity. Additionally, steel wool being made by shaving a larger piece of steel plate or bar may require that the larger steel plate or bar have some softness so that it can be shaved easier. To make the steel softer, other alloys (such as lead) can be added to the steel plate or bar; however, the addition of other alloys decreases the purity of the steel. Such lubricants, alloys, or other materials used to produce such susceptors may be undesirable for heating and/or inhalation.

In some embodiments, the metal pieces 601 are elongated metal fibers or strands. In this embodiment, the metal pieces 601 can be low grade carbon steel. As shown in FIGS. 3A-3C, the metal fibers can be woven into a fabric-like sheet referred to as steel fabric. The steel fabric has the textured surface 604 that creates increased surface area that optimizes heat transfer and adhesion to the aerosol producing substrate 104 and eliminates oxygen in between the susceptor 106 and the aerosol producing substrate 104. The steel fabric can degrade over time, particularly after it has been exposed to high aerosolizing temperatures. Preferably, the steel fabric has sufficient malleability to bend and be formed in to a fine screen. In order for the fibers to be sufficiently malleable, alloys can be added to the steel; however, this decreases the purity of the susceptor 106.

By way of example only, a wire mesh weaving machine can be used to create the steel fabric. In one example, the warp (long threads running the length of the roll) are evenly spread and are fed through two healds. Alternate wires go through front and back healds. The weft thread runs across the width of the roll and is fed through the warp when the weaving loom is open. Every weft thread can be cut to the same length and is wider than the required width of the mesh roll being manufactured. The distance between the weft wires can be controlled by a weaving reed that is mounted on a reciprocating beam that pushes every weft wire into place. After every weft wire is positioned, the front and back heald travel to either the upper position or the lower position depending on where they were previously positioned (either up or down); the crossing of these warp threads trap the last weft thread in place.

The cycle repeats until the length of woven mesh is manufactured. After the weave has occurred the machine goes through a process of calendaring. The calendaring process passes the mesh through opposing rollers that are set to create the desired compression off the woven ‘material’. Depending on the compression force applied, the strands of the mesh are crushed at the points where the warp and weft threads cross each other. The wires subsequently change from round wires to a more oval cross section. This changes the surface area of the mesh, reducing the spaces between the wires without changing its mass. The calendaring process also creates a more compact and robust ‘material’.

After calendaring, the mesh ‘material’ is wound onto a rotating beam. The beam is then used to transport the ‘material’ to the next process, slitting. The beams is positioned in a slitting machine where the ‘material’ is fed through a number of accurately positioned rotating blades that cut the wire mesh ‘material’ into the precise width required. The slit material is wound onto drums in which they will be packed.

A cleaning process and a drying and packing process can be used that will prevent any degradation/rusting of the materials while in transit and storage (the rolls can also be wrapped in containers in an oxygen free atmosphere).

Rolls made to the length of the aerosol producing substrate (e.g. tobacco portion) minus the thickness of the aerosol producing substrate, can be specified at each end of the susceptor 106 so as to ensure full encapsulation of the susceptor 106 will be produced. Before being fed into the aerosol producing substrate manufacturing machine, the rolls of susceptor 106 material will be inserted into ‘susceptor preparation and testing machine’ that uncoils and straightens the wire mesh ‘material’, clean them using a number of processes before finally cutting and crimping the material accurately to a specified width. The crimping prevents the loss of any strands. Cutting can be done by rotating knives positioned to ensure cut between the weft wires to ensure the same mass and electromagnetic characteristics of each final susceptor 106. The final stage or preparation can involve each individual susceptor 106 being electromagnetically checked by the machine to ensure the characteristics are in specification. The ‘good’ susceptors 106 can be placed into a magazine from which the aerosol producing substrate manufacturing machine will pick them.

The susceptor 106 preparation and testing machine may require an output speed of up to 20,000 pieces per minute so it is likely there may be a number of susceptor material rolls being unwound and processed in parallel. First machines can have a lower output and may only require a single roll at a time with up to 5 rolls in parallel being processed. The most important function of the machine is to ensure a consistent and clean susceptor 106.

Consistency can be achieved by supplying materials to a physical and materials specification. Accurate cutting can be achieved by one of a number of methods, such as rotating self-sharpening knife and anvil or by rotating crimp cutting. Delivery of only consistent susceptors 106 can be achieved by a rotating electromagnetic coil and associated electronics to confirm the characteristic of susceptors 106 going into the product.

The susceptors 106 can be delivered to a specification that includes a cleaning requirement and a packing specification for the products from the roll maker. The susceptors 106 should be free from bacteria and organic material before they are introduced to the aerosol producing substrate portion and that can be achieved by a combination of ‘washing’ the unwinding roll, induction heating of the roll as it is unwound before, and/or the use of known cleaning processes/techniques on the unwinding roll or elsewhere in the process.

The metals used in the process of making the material can be different or the same, of different wire diameters and shapes or the same. The product can be calendared to different degrees by varying the settings/pressure applied.

The steel wool and the steel fabric embodiments can have the disadvantage of being too loose and not having sufficient magnetic properties, thereby, making the heating process inefficient. To overcome these disadvantages, the steel wool or the steel fabric susceptors can be fused together into a single, unitary fused metal sheet, for example, using a hot press to apply high temperature and pressure. In some embodiments, the metal pieces 601 can be fused together without first being woven or intertwined (as in the case of the steel fabric or steel wool) to form what is referred to as metal paper. The fused metal sheet has a good magnetic properties and heats faster than when they are loosely intertwined or woven. In alternative embodiments, however, loose steel wool may be used for the appropriate application and inductive power.

In any of the fused metal susceptor embodiments discussed herein, once the fused metal sheet is exposed to high temperatures, the fused metal sheet may lose its cohesiveness and become degradable (or de-fused). Exposing a fused metal sheet to water after it has been heated can also corrode or degrade the metal sheet back into metal pieces 601 even faster. In addition, the heated metal may oxidize more rapidly after heating, further hastening the degradation.

A surprising difference between using the steel fabric versus the sintered susceptor is how fast and easily the steel susceptors 106 made via the sintering process tend to break down after heating. In one example, before use (i.e. heating), the susceptor 106 was a single, unitary piece that could be held and compressed between the ground tobacco with high pressure. After use (heating), however, the susceptor 106 crumbled into small pieces of sand-like, granular, or powder material. Also, the grains of iron could be rubbed between the fingers and it did not have any sharp edges.

To improve the evenness, efficiency, and consistency of conduction of the susceptor 106, the manufacturing process should be able to make susceptors 106 with substantially the same characteristics (for example, substantially the same density) over and over again. For example, the steel fabric has a consistent density because of the weave pattern. Steel wool can achieve consistent density through its compression and stretching phases. The loose metal pieces can be made into a consistent density using a magnetic drum. The magnetic drum can pick up the magnetic metal pieces 601 and discard non-magnetic pieces. After the magnetic metal pieces 601 are collected, they can be sent through a press to create even density. Simultaneously, the pressed metal pieces can be exposed to heat for the fusion process. In some embodiments, heat can be applied after being pressed.

As the susceptors 106 are being formed, they can be exposed to a magnetic field, and the electromagnetic induction properties of the susceptor 106 measured. Depending on the measured electromagnetic induction properties, a given susceptor 106 can be accepted or rejected as the susceptor 106 comes out of production. If a given susceptor 106 is rejected, the raw materials can be adjusted during the manufacturing process - i.e., while the susceptors are being manufactured and coining out of production - to create susceptors 106 with magnetic properties that fall within a desired standard. In other words, magnetic properties of a susceptor can be measured and adjusted simultaneously.

The electromagnetic induction properties of the susceptor 106, includes, but is not limited to, the magnetic permeability and the bulk resistance of the material(s) it is constructed of. Without being bound by theory, it is believed the susceptor 106 of the present application has improved electromagnetic induction properties over prior art susceptors as there are two mechanisms that contribute to induction heating: (1) magnetic hysteresis and (2) eddy current heating. Magnetic hysteresis requires use of a metal(s) with high permeability- such as high purity iron. Eddy current heating relies on the susceptor material having a high bulk resistance. By using a composition made from powered fragmented ferrous metal, the bulk resistance of the susceptor is greatly increased, thereby further increasing the heating effect from eddy currents. Some improvements of the susceptor 106 of the present application include, but are not limited to, the use of highly purified iron with high permeability, the construction of the susceptor from smaller pieces 601 (i.e., fragments, particles, powered iron, and the like), and the fragmented surface structure of the susceptor that further contributes to its bulk resistivity.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention not be limited by this detailed description, but by the claims and the equivalents to the claims appended hereto.

What is claimed is:

1. A susceptor, comprising a plurality of metal pieces incorporated together as a unitary piece, wherein the unitary piece is degradable after use.

2. The susceptor of claim 1, wherein the metal pieces comprise carbon steel thread.

3. The susceptor of claim 2, wherein the unitary piece comprises a weave pattern.

4. The susceptor of claim 1, wherein the metal pieces are steel pieces.

5. The susceptor of claim 4, wherein the steel pieces are metal particles.

6. The susceptor of claim 5, wherein the steel pieces are fused together.

7. The susceptor of claim 1, wherein the metal pieces comprise iron powder.

8. The susceptor of claim 1, wherein the unitary piece is configured to degrade once heated.

9. A method of manufacturing a susceptor, comprising:
a) collecting a plurality of metal pieces;
b) incorporating the collected metal pieces into a unitary piece, whereby the susceptor is created, wherein the created susceptor is configured to degrade when exposed to an aerosolizing temperature.

10. The method of claim 9, further comprising flattening the unitary piece into a flat sheet with a press.

11. The method of claim 9, wherein the metal pieces are carbon steel thread.

12. The method of claim 11, wherein incorporating the metal pieces into the unitary piece comprises weaving the carbon steel thread together.

13. The method of claim 12, wherein flattening the unitary piece further comprises exposing the unitary piece to heat to fuse the metal pieces together into the flat sheet.

14. The method of claim 9, wherein the metal pieces are collected with a magnetic drum.

15. The method of claim 14, wherein incorporating the metal pieces into a unitary flat sheet comprises fusing the metal pieces together with pressure and heat.

16. The method of claim 15, wherein after the susceptor is created, the susceptor is exposed to a magnetic field to test a magnetic property.

17. The method of claim 16, further comprising the step of adjusting the amount of metal pieces flattened in the press based on the magnetic property.

18. The method of claim 9, further comprising fusing the metal pieces together.

19. The method of claim 18, wherein fusing the metal pieces together is by sintering.

20. The method of claim 19, wherein the metal pieces are sintered using a method selected from the group consisting of microwave sintering, ultrasonic assisted sintering, direct pressure sintering, electric current assisted sintering, e-beam sintering, and powdered metallurgy sintering.
